(19) United States
(12) Patent Application Publication
(10) Pub. No.: US 2026/0192575 A1
(43) Pub. Date: Jul. 9, 2026

(54) HEATING STRUCTURE FOR A DIRECT-TO-FILM POWDER SHAKING MACHINE WITH INTEGRATE SMOKE FILTRATION SYSTEM

(71) Applicant: Chang Lee, Cerritos, CA (US)

(72) Inventor: Chang Lee, Cerritos, CA (US)

(21) Appl. No.: 19/010,455

(22) Filed: Jan. 6, 2025

(51) Int. Cl. B41J 11/00; B01D 46/00; B01D 46/10; B01D 53/02; B41J 29/377; H05B 3/22

(52) U.S. Cl. CPC B41J 11/0015; B01D 46/0036; B01D 46/0047; B01D 46/10; B01D 53/02; B41J 29/377; H05B 3/22; B01D 2253/102; B01D 2273/30; B01D 2279/45

(57) ABSTRACT

A DTF powder shaking machine heating structure and DTF powder shaking machine is disclosed herein. The DTF powder shaking machine heating structure includes a shell assembly and a heating plate arranged below the shell assembly. The shell assembly and the heating plate form an air inlet. The outer surface of the heating plate is provided with a DTF printing film and the inner surface of the heating plate is provided with a conductive layer to supply heat to the DTF printing film by electricity. The embodiments ensure that the DTF printing film is heated evenly, and the hot melt powder bonded to the DTF printing film will melt to maintain the best effect. In addition, the DTF printing film is directly heated by the heating plate, which has less energy loss and high thermal energy utilization rate, thereby reducing the overall energy consumption.

### TECHNICAL FIELD

The embodiments disclosed herein generally relate to direct-to-film (DTF) printing machines, and more specifically to a DTF powder shaking machine having an integrated smoke filtration system.

### BACKGROUND

The existing DTF powder shaking machines uses the heat radiation of the heating tube to heat the DTF printing film during use. This heating method results in uneven heating which causes poor melting of the hot melt powder bonded to the printing film and requires high energy consumption and low thermal energy utilization efficiency.

### SUMMARY OF THE INVENTION

This summary is provided to introduce a variety of concepts in a simplified form that is further disclosed in the detailed description of the embodiments. This summary is not intended for determining the scope of the claimed subject matter.

The present disclosure provides a DTF powder shaking machine heating structure and DTF powder shaking machine to overcome the deficiencies of the prior art. In order to realize the above purpose, the present disclosure adopts various technical improvements.

In the first aspect, the present disclosure provides the DTF powder shaking machine heating structure, comprising: a shell assembly and a heating plate arranged below the shell assembly, the shell assembly and the heating plate form an air inlet, the outer surface of the heating plate is provided with a DTF printing film, the inner surface of the heating plate is provided with a conductive layer to supply heat to the DTF printing film by electricity.

The DTF powder shaking machine heating structure provided by the present disclosure has beneficial effects as follows:

By arranging the heating plate below the shell assembly, the shell assembly and the heating plate form the air inlet, the outer surface of the heating plate is provided with the DTF printing film, the inner surface of the heating plate is provided with the conductive layer. After the conductive layer is energized, the heating plate works to heat the DTF printing film, so that the DTF printing film is heated evenly, and the hot melt powder bonded to the DTF printing film will melt to maintain the best effect. In addition, the DTF printing film is directly heated by the heating plate, which has less energy loss and high thermal energy utilization rate, thereby reducing the overall energy consumption.

In the second aspect, the present disclosure provides the DTF powder shaking machine, comprising the DTF powder shaking machine heating structure as described above.

The DTF powder shaking machine provided by the present disclosure has beneficial effects as follows:

By arranging the heating plate below the shell assembly, the shell assembly and the heating plate form the air inlet, the outer surface of the heating plate is provided with the DTF printing film, the inner surface of the heating plate is provided with the conductive layer. After the conductive layer is energized, the heating plate works to heat the DTF printing film, so that the DTF printing film is heated evenly, and the hot melt powder bonded to the DTF printing film will melt to maintain the best effect. In addition, the DTF printing film is directly heated by the heating plate, which has less energy loss and high thermal energy utilization rate, thereby reducing the overall energy consumption of the DTF powder shaking machine.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the DTF powder shaking machine heating structure, according to some embodiments;

FIG. 2 illustrates a cross-sectional view of the DTF powder shaking machine heating structure, according to some embodiments;

FIG. 3 illustrates an exploded view of the DTF powder shaking machine heating structure, according to some embodiments: and

FIG. 4 illustrates a perspective view of the DTF powder shaking mechanism having the heating structure mounted thereto, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

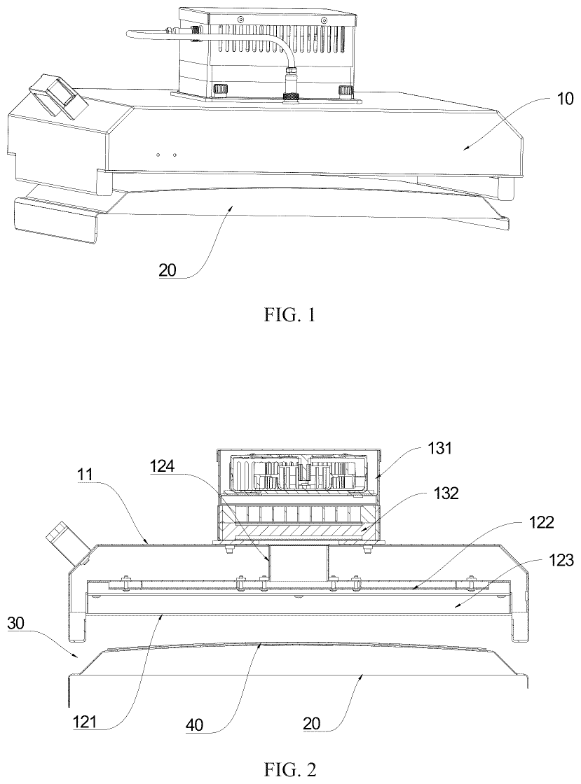

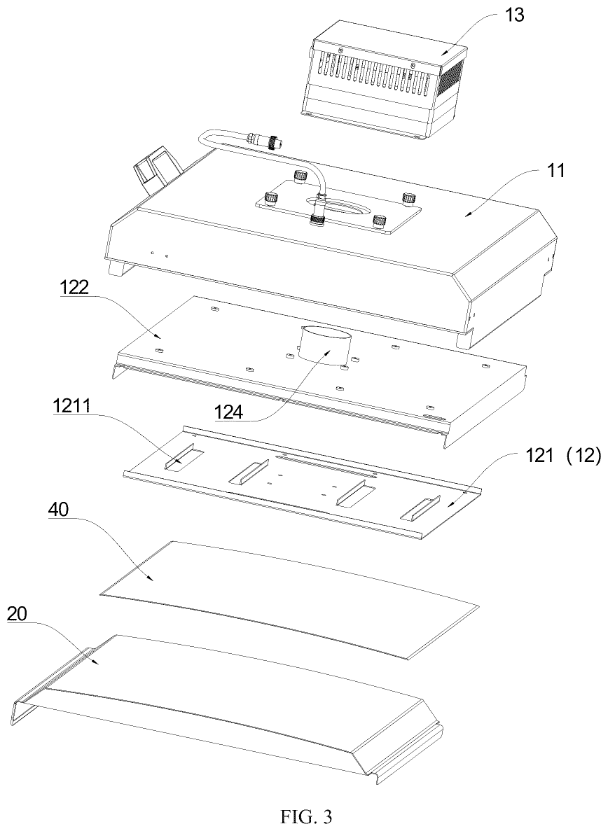

Referring to FIG. 1 to FIG. 3, the present disclosure provides a DTF powder shaking machine heating structure, comprising: a shell assembly 10 and a heating plate 20 arranged below the shell assembly 10, the shell assembly 10 and the heating plate 20 form an air inlet 30, the outer surface of the heating plate 20 is provided with a DTF printing film 40, the inner surface of the heating plate 20 is provided with a conductive layer to supply heat to the DTF printing film 40 by electricity.

Specifically, by arranging the heating plate 20 below the shell assembly 10, the shell assembly 10 and the heating plate 20 form the air inlet 30, the outer surface of the heating plate 20 is provided with the DTF printing film 40, the inner surface of the heating plate 20 is provided with the conductive layer. After the conductive layer is energized, the heating plate 20 works to heat the DTF printing film 40, so that the DTF printing film 40 is heated evenly and the hot melt powder bonded to the DTF printing film 40 will melt to maintain the best effect. In addition, the DTF printing film 40 is directly heated by the heating plate 20, which has less energy loss and high thermal energy utilization rate, thereby reducing the overall energy consumption.

Specifically, the conductive layer is connected to the power supply through wires to achieve power supply.

In one embodiment, the conductive layer is formed by vulcanizing the heated copper foil.

Specifically, the conductive layer is formed by vulcanizing the heated copper foil, the conductive layer and the heating plate 20 are an integrated structure, that is, the heated copper foil and the heating plate 20 are vulcanized into one, so as to form a conductive layer on the inner surface of the heating plate 20.

In one embodiment, the shell assembly 10 comprises a shell 11, a spacing portion 12 connected to the inner side of the shell 11, and an exhaust portion 13 connected to the outer side of the shell 11, the DTF printing film 40 generates smoke after being heated, and the smoke passes through the spacing portion 12 and is discharged from the exhaust portion 13.

Specifically, by providing a spacing portion 12 inside the shell 11 and an exhaust portion 13 outside the shell 11, the smoke first passes through the spacing portion 12 and then is discharged by the exhaust portion 13. The smoke is filtered by the exhaust portion 13 and then discharged, which reduces the possibility of environmental pollution. In addition, the smoke first enters the spacing portion 12, thereby preventing the smoke from overflowing along the air inlet 30 on both sides of the shell 11.

The shell assembly 10 forms a housing when connected to the heating plate 20 which protects the inner components of the DTF powder shaking machine. The air inlet 30 is formed by a space between the shell assembly 10 and the heating plate 20 to enable the ingress of air therethrough.

In one embodiment, the exhaust portion 13 comprises an exhaust fan 131 and a filter plate 132, the filter plate 132 is installed on the exhaust fan 131, and the smoke passes through the filter plate 132 and is discharged by the exhaust fan 131. In such, the exhaust fan 131 prevent smoke from collecting within the air inlet 30.

Specifically, the smoke first passes through the spacing portion 12, then is filtered by the filter plate 132, and then is discharged by the exhaust fan 131. The filter plate 132 filters and absorbs impurities and particles in the smoke to play a purification role, so that the smoke discharged by the exhaust fan 131 will not cause environmental pollution. In addition, the filter plate 132 can be detachably connected to the exhaust fan 131. After the filter plate 132 has been used for a period of time, it can be replaced with a new filter plate 132 to ensure the filtering effect.

In one embodiment, the filter plate 132 is composed of a filter paper layer and an activated carbon layer, and the filter paper layer is located below the activated carbon layer.

Specifically, the filter paper layer and the activated carbon layer have good filtering and adsorption effects and are affordable and cost-effective.

In one embodiment, the exhaust fan 131 is installed on the outer side of the shell 11 by screws, and a sealing ring is provided between the exhaust fan 131 and the shell 11.

Specifically, the exhaust fan 131 is installed on the outside of the shell 11 by screws, and the connection is firm and easy to disassemble and assemble. In addition, the sealing ring is provided to play a sealing role so that smoke will not overflow along the gap between the exhaust fan 131 and the shell 11.

In one embodiment, the spacing portion 12 comprises a smoke baffle 121 and a spacing plate 122 connected to the smoke baffle 121, the smoke baffle 121 and the spacing plate 122 form a spaced area 123, the smoke baffle 121 is provided with at least one opening 1211, the smoke is discharged by the exhaust fan 131 and passes through the opening 1211, the spaced area 123 and the filter plate 132 in sequence.

Specifically, in the prior art, if an external smoke extraction device is connected, the temperature near the heating plate will be affected, resulting in a poor baking effect. In the present disclosure, the smoke passes through the opening 1211, the spaced area 123 and the filter plate 132 in sequence and is then exhausted by the exhaust fan 131. The smoke circulates in the spaced area 123 and is then extracted and exhausted. In this way, the smoking will not lose heat, causing the temperature below the smoke baffle 121 to drop, thereby effectively ensuring the baking effect. [0033] Preferably, the smoke baffle 121 and the spacing plate 122 are connected by screws or snap-fitting.

In one embodiment, the outer side of the spacing plate 122 is provided with a conduit 124 connected to the spaced area 123, the filter plate 132 is connected to the conduit 124.

Specifically, the shell 11 is provided with an opening hole corresponding to the conduit 124. The smoke enters the conduit 124 from the airtight area 123 and then enters the filter plate 132 along the opening hole. The smoke flows stably and efficiently without overflow.

In one embodiment, a sealing member is provided between the smoke baffle 121 plate and the spacing plate 122.

Specifically, the sealing member is provided to play a sealing role so that smoke in the spaced area 123 will not overflow along the gap between the smoke baffle plate 121 and the spacing plate 122.

In one embodiment, the number of the openings 1211 is between 3 to 6 openings.

Specifically, a plurality of openings 1211 are evenly distributed on the smoke baffle plate 121, so that smoke can quickly enter the spaced area 123, thereby preventing smoke from overflowing from the air inlet 30. Preferably, the number of the openings 1211 is four.

In one embodiment, the spacing plate 122 is connected to the shell 11 by screws, which is firmly connected and easy to operate.

In one embodiment, the exhaust fan 131 is also connected with an air guide pipe, through which the extracted smoke is discharged to the outdoors or a designated area.

A DTF powder shaking machine, wherein it comprises the DTF powder shaking machine heating structure as described above.

Specifically, by arranging the heating plate 20 below the shell assembly 10, the shell assembly 10 and the heating plate 20 form the air inlet 30, the outer surface of the heating plate 20 is provided with the DTF printing film 40, the inner surface of the heating plate 20 is provided with the conductive layer. After the conductive layer is energized, the heating plate 20 works to heat the DTF printing film 40, so that the DTF printing film 40 is heated evenly and the hot melt powder bonded to the DTF printing film 40 will melt to maintain the best effect. In addition, the DTF printing film 40 is directly heated by the heating plate 20, which has less energy loss and high thermal energy utilization rate, thereby reducing the overall energy consumption of the DTF powder shaking machine.

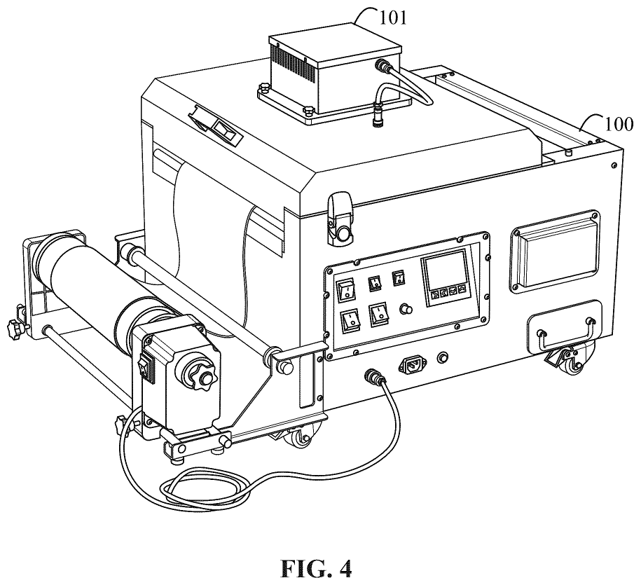

FIG. 4 illustrates the DTF powder shaking machine 100 having the heating structure 100 (as is shown in FIGS. 1-3) mounted thereon. The heating structure 101 is mounted in a suitable position such that the heating structure to provide even heating and improves melting of the hot melt powder. The heating structure 101 may also reduce energy consumption and enhance the utilization of thermal energy. Further the position of the heating structure enhances smoke ventilation by directing the flow of smoke from the powder shaking machine 100.

This heating method results in uneven heating which cases poor melting of the hot melt powder bonded to the printing film and requires high energy consumption and low thermal energy utilization efficiency.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A heating structure for a direct-to-film powder shaking machine, comprising:
a shell assembly and a heating plate arranged below the shell assembly to form an air inlet;
an outer surface of the heating plate provided with a direct-to-film printing film;
an inner surface of the heating plate provided with a conductive layer to supply heat to the direct-to-film printing film via electricity.

2. The heating structure for a direct-to-film powder shaking machine of claim 1, wherein the conductive layer is formed by vulcanizing the heated copper foil.

3. The heating structure for a direct-to-film powder shaking machine of claim 1, wherein the shell assembly comprises:
a shell;
a spacing portion connected to the inner side of the shell, and an exhaust portion connected to the outer side of the shell, wherein the direct-to-film printing film generates smoke after being heated, and the smoke passes through the spacing portion and is discharged from the exhaust portion.

4. The heating structure for a direct-to-film powder shaking machine of claim 1, wherein the exhaust portion comprises an exhaust fan and a filter plate, the filter plate being installed on the exhaust fan, and the smoke passes through the filter plate and is discharged by the exhaust fan.

5. The heating structure for a direct-to-film powder shaking machine of claim 1, wherein the filter plate is comprised of a filter paper layer and an activated carbon layer.

6. The heating structure for a direct-to-film powder shaking machine of claim 1, wherein the spacing portion comprises a smoke baffle and a spacing plate connected to the smoke baffle to form a spaced area, the smoke baffle is provided with at least one opening, the spaced area and the filter plate.

7. The heating structure for a direct-to-film powder shaking machine of claim 1, wherein the outer side of the spacing plate is provided with a conduit connected to the spaced area, and wherein the filter plate is connected to the conduit.

8. The heating structure for a direct-to-film powder shaking machine of claim 1, wherein a sealing member is provided between the smoke baffle plate and the spacing plate.

9. The heating structure for a direct-to-film powder shaking machine of claim 1, wherein the exhaust fan is connected with an air guide pipe.

10. The heating structure for a direct-to-film powder shaking machine of claim 1, further comprising a direct-to-film powder applied to the direct-to-film printing film.

11. The heating structure for a direct-to-film powder shaking machine of claim 1, further comprising a power source to provide electrical energy to the conductive layer of the direct-to-film printing film.

12. A heating structure for a direct-to-film powder shaking machine, comprising:
a shell assembly and a heating plate arranged below the shell assembly to form an air inlet;
an outer surface of the heating plate provided with a direct-to-film printing film;
an inner surface of the heating plate provided with a conductive layer to supply heat to the direct-to-film printing film via electricity; and
an exhaust portion connected to the outer surface, the exhaust portion to enable the egress of smoke driven by an exhaust fan to prevent the buildup of smoke within the air inlet.

13. The heating structure for a direct-to-film powder shaking machine of claim 12, wherein the conductive layer is formed by vulcanizing the heated copper foil.

14. The heating structure for a direct-to-film powder shaking machine of claim 13, wherein the shell assembly comprises:
a shell;
a spacing portion connected to the inner side of the shell, wherein the direct-to-film printing film generates smoke after being heated, and the smoke passes through the spacing portion and is discharged from the exhaust portion.

15. The heating structure for a direct-to-film powder shaking machine of claim 14, wherein the exhaust portion comprises a filter plate installed on the exhaust fan, and wherein the smoke passes through the filter plate and is discharged by the exhaust fan.

16. The heating structure for a direct-to-film powder shaking machine of claim 15, wherein the filter plate is comprised of a filter paper layer and an activated carbon layer.

17. The heating structure for a direct-to-film powder shaking machine of claim 16, wherein the spacing portion comprises a smoke baffle and a spacing plate connected to the smoke baffle to form a spaced area, the smoke baffle is provided with at least one opening, the spaced area and the filter plate.

18. The heating structure for a direct-to-film powder shaking machine of claim 17, wherein the outer side of the spacing plate is provided with a conduit connected to the spaced area, and wherein the filter plate is connected to the conduit.

19. The heating structure for a direct-to-film powder shaking machine of claim 18, wherein a sealing member is provided between the smoke baffle plate and the spacing plate.

20. The heating structure for a direct-to-film powder shaking machine of claim 19, wherein the exhaust fan is connected with an air guide pipe.
